(19) United States
(12) Patent Application Publication
(10) Pub. No.: US 2025/0317086 A1
(43) Pub. Date: Oct. 9, 2025

(54) METHOD OF CONTROLLING A MOTOR AND A MULTIPLE LANE MOTOR CIRCUIT

(71) Applicant: ZF Automotive UK Limited, Solihull (GB)

(72) Inventors: Kevin Rushgrove, Lichfield (GB); Sourabh Renavikar, Solihull (GB)

(21) Appl. No.: 18/820,437

(22) Filed: Aug. 30, 2024

(30) Foreign Application Priority Data
Sep. 1, 2023 (GB) 2313388.7

(51) Int. Cl. H02P 29/028; B62D 5/00; B62D 5/04; H02P 25/22

(52) U.S. Cl. CPC H02P 29/028; B62D 5/001; B62D 5/0421; B62D 5/0472; B62D 5/0487; H02P 25/22

(57) ABSTRACT

A method of controlling an electric steering system having a multiple phase permanent magnet electric motor having a plurality of motor phases that in normal operation applies a torque to a part of the system connected to the road wheels to control the steering angle of the road wheels, the motor being driven by a bridge circuit that includes a set of switches that can be opened and closed to selectively connect each phase to a supply voltage of a power supply or to a ground in response to signals output from a bridge driver circuit, the method comprising, in an event of a fault that prevents the motor applying a torque that enables the roadwheels to be steered, operating switches of the bridge circuit independent of the bridge driver to short each phase of the motor so as to dampen the rotation of the motor and at the same time turn of the power supply to the bridge circuit.

### CROSS-REFERENCE TO RELATED APPLICATIONS

This application claims priority to Patent Application No. GB2313388.7 filed on Sep. 1, 2023, the disclosure of which is incorporated herein by reference in its entirety.

### TECHNICAL FIELD

This disclosure relates to methods of controlling a motor of an electric steering system, a motor circuit for use in an electric steering system and to a vehicle including both a front wheel steering and a rear wheel steering where one of the systems include a motor circuit.

### BACKGROUND

Most all current passenger vehicles and commercial vehicles intended to be driven on a highway have steerable front wheels. The driver may turn the front wheels by turning a steering wheel or yoke. With electrically assisted steering systems, the steering wheel is connected to the road wheels directly through a mechanical linkage, and movement of the steering wheel produces a corresponding change in the steering angle of the road wheels. To reduce the effort needed to turn the steering wheel the torque applied by the driver is measured and fed into a control system which instructs an electric motor to generate a torque of the same sense as that applied by the driver. This motor torque is then applied to a part of the steering system that is connected to the wheels to assist the driver.

A recent trend has been to provide a steering system which does not have a direct connection from the steering wheel to the road wheels, a system known as electric steering or steer-by-wire. This brings a number of benefits in packaging and to an extent safety as there is no longer a rigid steering column in front of the driver in the event of a front impact. To steer the vehicle, the driver applied torque at the steering wheel is measured and this is fed into a controller which causes an electric motor to apply a torque to a steering rack that is connected to the road wheels. This torque causes the motor to rotate and the rack to move to thereby steer the wheels. A secondary motor may also be connected to the steering wheel that generates a torque that opposes the driver turning the wheel to give a desired steering feel and to simulate the feedback that the driver would feel if there was a mechanical connection directly to the road wheels from the steering wheel.

An increasing number of passenger vehicles and commercial vehicles also have steerable rear wheels. Rear wheel steering has been known for specialist vehicles such as forklift trucks for some time but is only recently becoming common on roadgoing vehicles. The provision of the steerable rear wheels in addition to steerable front wheels can help in reducing the turning circle of the vehicle by turning in the opposition direction to the front wheels. They may also be used to increase stability during high speed manoeuvres such as a lane change by turning the rear wheels in the same direction as the front wheels.

In the event of a fault in a steering system, for example a steer by wire system, which prevents the control system from driving motor to apply a torque to turn the road wheels, the forces acting on the road wheels may attempt to back drive the motor causing the steering angle of the road wheels to vary in an uncontrolled manner. The driver cannot resist this because there is no direct mechanical linkage from the steering wheel to the road wheels. In an emergency situation where such a fault has occurred and the vehicle is travelling at high speeds, the road wheels may deviate from a straight ahead position by a substantial amount causing the vehicle to drift laterally across the highway. This could place the driver in danger, for example by placing the vehicle onto the wrong side of a two way highway.

As steering systems are considered to be safety critical systems, it is known to use a motor having dual lanes. Each lane comprises a control circuit that generates control signals for a driver circuit, the driver circuit varying the voltage applied to the motor to generate a required torque. In the case of a multi-phase motor each phase may be connected to a supply voltage or to an earth through a pair of switches, the switches forming the drive circuit and being opened and closed according to the values of the control signals from the control circuit. This allows steering control to be retained in the event that one of the lanes has a fault. However, it remains possible for both lanes to be at fault and the control of the steering of the front wheels to be lost.

To ensure the safety of the occupants of the vehicle it has been proposed that in the event of a fault of the front wheel steering in which the control of the steering angle of the wheels is lost the vehicle can switch to an emergency steering mode. This emergency steering mode is intended to allow a separate and independent system to laterally control the vehicle. This is to allow the vehicle to manoeuvre to a safe location. This can be achieved using a process of brake steer in which individual brakes are applied to generate a vehicle yaw or by steering the vehicle from the rear using the rear wheel steering. This way the vehicle can be safely moved to the side of a highway where it can be brought to a stop out of the flow of traffic on the highway. The applicant has appreciated that the success of such an emergency steering mode in safely steering a vehicle to safety depends on the behaviour of the uncontrolled front wheels. A mechanism or system to lock the front wheels in a fixed steering orientation when in such a fault mode, or at least provide a high resistance to movement, is therefore desirable.

Once known system, shown in U.S. Pat. No. 11,128,241B1, shows a motor control system shorts motor windings of a motor so that the motor generates a braking torque which all or some of the electric control units of the motor are disabled or failed. The control circuit includes a shorting circuit having a set of additional switches that short out each phase of the motor at a point between the inverters that drive the bridge and the motor phase windings.

### SUMMARY

What is needed is to provide a method and a system which restricts the movement of the front road wheels of a vehicle having an electric power steering system in the event of a fault in the steering system that prevents the wheels being steered.

According to a first aspect, a method of controlling an electric steering system of the kind comprising a multiple phase permanent magnet electric motor having a plurality of motor phases that in normal operation applies a torque to a part of the system connected to the road wheels to control the steering angle of the road wheels. The motor is driven by a bridge circuit that includes a set of switches that can be opened and closed to selectively connect each phase to a supply voltage of a power supply or to a ground in response to signals output from a bridge driver circuit. An exemplary arrangement of the disclosed method comprises, in an event of a fault that prevents the motor applying a torque that enables the roadwheels to be steered, operating switches of the bridge circuit, independent of the bridge driver, to short each phase of the motor so as to dampen the rotation of the motor and at the same time turn off the power supply to the bridge circuit.

By shorting each phase of the motor out to ground the bridge driver is in effect disabled as it is no longer able to apply current to a motor phase and by isolating the power supply, the method ensures that the power supply is not able to be shorted out in the event of a fault causing a phase to be connected to the power supply.

The method may isolate the bridge circuit from the power supply by switching off the power supply or by opening one or more isolating switches between the power supply and the bridge circuit.

Where the bridge circuit comprises for each phase an upper switch, which when closed connects a phase to the power supply, and a lower switch, which connects the phase to a ground, the method may short each phase by closing the lower side switch of each phase of the bridge circuit.

The method may override the operation of the lower bridge switches by the bridge driver preventing the bridge driver from opening the lower switches.

The switches may comprise transistors which are turned ON and OFF by the bridge driver circuit applying a non-zero valued voltage drive signal to a gate of the switch and the method may short a phase by connecting the gate or base of each switch to a non-zero value voltage to turn the switch ON.

The motor may include a control circuit that generates control signals that are applied to the bridge driver circuit indicative of a torque to be applied by the motor. The bridge driver circuit may generate appropriate switching pattern waveforms to apply to each switch of the bridge in response to receiving the control signals.

The method may comprise monitoring the control circuit and generating a bridge driver disable signal in the event of a fault of the control circuit, the method monitoring the signal to determine when to short the phases of the motor to damp the motor rotation.

The motor may comprise a dual lane motor having a first lane and a second lane, each lane comprising a set of phase windings, a bridge circuit, bridge driver, a control circuit and a fault detection circuit that monitors the control circuit and outputs a bridge driver disable signal in the event of a fault. The method may monitor the two bridge driver disable signals and short out each phase to ground to damp the rotation of the motor only when a fault in both control circuits is indicated by the value of the bridge driver disable signals whilst at the same time preventing any shorted bridge circuit from receiving power from the power supply, whether due to a failed switch or a fault in the control circuit or driver that opens and closes the switches.

By only damping when the control circuit of both lanes are faulty, the method allows the system to continue to provide steering when one lane is functioning but safely damps the motor when both lanes are faulty.

Where there are two lanes, each lane of the motor comprising a respective set of phase windings driven by a bridge circuit that selectively connects each phase to a positive supply or to a ground, the method may comprise in the event of a fault that prevents the wheels being steered shorting each phase of both lanes of the motor to the ground so as to damp the rotation of the motor and at the same time preventing both of the bridge circuits from receiving power from the power supply.

Shorting the phases of both lanes provides the potential for increased braking torque compared with the shorting of only one lane.

The method may comprise combining the bridge driver disable signals using logic such that both signals must be indicative of a fault for all phases of a motor lane to be shorted to ground.

According to a second aspect, the disclosure provides a multiple lane motor circuit for driving a multiple lane permanent magnet motor of an electric steering system, each lane of the motor comprising a plurality of motor phase windings, permanent magnets, the multiple lane motor circuit comprising:
a first motor lane comprising:
a first bridge circuit comprising a set of top switches that each selectively connect a respective phase of the motor to a supply voltage of a power supply and a set of bottom switches that each selectively connect a respective phase of the motor to ground;
a first bridge driver circuit which outputs, respectively, drive signals for each of the switches of the bridge so as to control the voltage applied to each phase over time in response to a set of control signals thereby controlling the current flowing through each phase of the motor,
a first control circuit which is configured to output control signals to the bridge driver; and
a first fault detection circuit that outputs a bridge driver disable signal in the event of a fault in the line to disable the bridge driver associated with the lane,
a second motor lane comprising:
a second bridge circuit comprising a set of top switches that each selectively connect a respective phase of the motor to a supply voltage of a power supply and a set of bottom switches that each selectively connect a respective phase of the motor to ground;
a second bridge driver circuit which outputs respectively drive signals for each of the switches of the bridge so as to control the voltage applied to each phase over time in response to a set of control signals thereby controlling the current flowing through each phase of the motor, and
a second controller which is configured to output control signals to the bridge driver; and
a second fault detection circuit that outputs a bridge driver disable signal in the event of a fault in the lane to disable the bridge driver associated with the lane,
and further comprising monitoring arrangement arranged to monitor the bridge driver disable signals and a safety damping circuit configured so that in the event that the monitoring arrangement determines that the bridge driver disable signals indicate that the control circuits of both lanes are faulty the safety damping circuit causes the bottom switches of the bridge driver to short each phase of at least one lane of the so as to dampen the rotation of the motor and at the same time isolates the top switches of the bridge circuit from the power supply.

The safety damping circuit may comprise a pair of switches arranged in series between a positive supply voltage and a switch of each phase of at least one lane of the motor, the switches comprising a first switch which is normally open and closed when the first bridge driver disable signal instructs disabling of the first bridge driver circuit and a second switch which is normally open and is closed when the second bridge driver disable signal instructs disabling of the second bridge driver circuit, configured such that only when both switches are closed is the short circuit applied to each phase of at least one lane to provide damping of the motor through the generation or braking torque.

The two switches in series perform a logical AND function, with both needing to be closed to apply the damping.

Each of the two switches of the safety damping circuit may comprise a transistor such as a MOSFET, the safety damping circuit being adapted to cause the switch to close by applying a positive voltage to a base of the switch to turn on the MOSFET allowing current to flow between the source and the drain.

When both switches of the safety damping circuit are closed, the safety damping circuit outputs a voltage at or close to the supply voltage which is used to turn on the bottom switches. This voltage may be fed to a gate driver which outputs an appropriate level voltage to the gate of the bottom switches.

The motor circuit may additionally include an isolation circuit comprising a set of isolating switches, one switch being located in series between the bridge circuit and each motor phase, each isolating switch being normally closed. The primary function of the switches is to allow for a break to be placed in each phase preventing a short circuit being formed in the event that a lane of the motor is at fault and the other lane is being used to control the steering of the road wheels.

In the event of a fault of both lanes, the isolation circuit may hold the isolation switches closed to allow for the damping to be intentionally introduced.

The motor circuit may comprise a duplicate safety damping circuit that comprises a pair of switches arranged in series between a positive supply and an end of each phase of the second lane of the motor. For example, the pair of switches may include a first switch which is normally open and closed when the first bridge driver disable signal instructs disabling of the first lane and a second first switch which is normally open and is closed when the second bridge driver disable signal instructs disabling of the second lane. Both switches are required to close to apply the positive voltage to the ends of each phase of the second lane.

Providing duplicate safety damping circuits enables the damping to be maximised as both lanes can be used to provide damping.

The two safety monitoring circuits may be combined to form a single circuit that can damp both lanes. However, having separate pairs of switches for a monitoring circuit of each lane provides a high level of redundancy and improve safety in the event of one of the switches failing to close when instructed.

The bridge disable signals and may be input to a power supply isolation block that isolates the top switches of the bridge from the supply to prevent the phases receiving the positive voltage from the power supply. This ensures that a positive voltage cannot be connected through a closed top switch of the bridge directly to the ground through the closed bottom switches.

The power supply isolation block may turn off a power supply for the bridge circuit, removing the positive voltage. The motor circuit may be arranged such that this power supply is independent from the power supply to the control circuits so that when this is turned off the control circuits may continue to function and the safety monitoring circuits may continue to function to turn On the bottom bridge switches as appropriate to generate the required motor damping effect.

Alternatively it may open a switch to isolate the top switches of the bridge from the positive voltage of the power supply.

The safety damping circuit, or each safety damping circuit when two are provided, may comprise a pair of switches arranged in series between a positive voltage of a power supply and the gate of each lower switch of the bridge circuit. The pair of switches include a first switch being normally open and closed when the first bridge driver disable signal instructs disabling of the first lane and a second first switch which is normally open and is closed when the second bridge driver disable signal instructs disabling of the second lane. Both switches need to close to apply the positive voltage to the gates of each phase of the lane.

The multiple lane motor may have only the first and second lanes, a so called dual lane motor. But the disclosure may be applied to motors having more than two lanes. Damping may be provided on at least one, or any number of the total motor lanes.

In accordance with a third aspect, the disclosure provides a front axle assembly for a steer by wire vehicle including a motor circuit of the second aspect and a multi phase dual lane permanent magnet electric motor which is operable to steer the front wheels of the vehicle.

In accordance with a third aspect, the disclosure provides a vehicle comprising a front wheel steering assembly and a rear wheel steering assembly in which the front wheel steering assembly includes a motor circuit of the second aspect of the disclosure.

### BRIEF DESCRIPTION OF THE DRAWINGS

There will now be described, by way of example only, one exemplary arrangement of the present disclosure with reference to and as illustrated in the accompanying drawings of which:

FIG. 1 is a plan view of a vehicle, including steerable front and rear wheels in which the front wheels are steered by a steer by wire assembly including a motor circuit in accordance with an exemplary arrangement of the disclosure.

FIG. 2 is a block diagram of key circuit blocks for the motor circuit of the steering system for the front wheels;

FIG. 3 is schematic of one bridges that provides current to the phases of one lane of the motor;

FIG. 4 is a representation of a typical FET that can be used as a switch in the bridge circuit of FIG. 3;

FIG. 5 is a schematic of part of the motor circuit for one lane showing the interaction of a monitoring circuit and a safety damping circuit with the bridge of that lane;

FIG. 6 is an identical schematic to FIG. 5 but showing the interaction of the monitoring circuit and safety damping circuit of the second lane;

FIG. 7 is a flowchart showing the behaviour of the circuits of FIGS. 2 to 6 in a variety of conditions including both normal function of the control circuits and a fault condition in one or both control circuits; and

FIG. 8 represents a dual motor which has two independents set of phases windings, each set defining three phases and driven by a separate bridge circuit.

### DETAILED DESCRIPTION

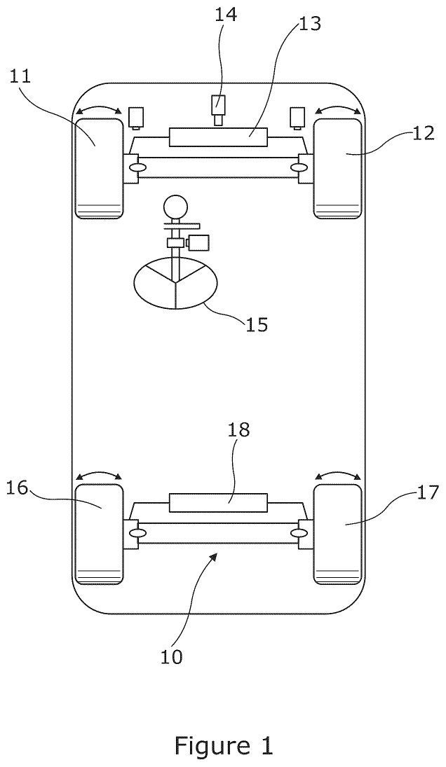

FIG. 1 is a schematic plan view of a passenger vehicle 10 which has both steerable front wheels and steerable rear wheels. The two front wheels 11, 12 are connected together by a steering rack 13 that can translate laterally across the vehicle body to turn the road wheels. The steering rack 13 is moved by an electric actuator assembly that includes a motor 14. The motor 14 is responsive to control signals from a motor circuit that converts a demanded road wheel steering angle into an appropriate position of the steering rack and drives the motor to ensure that the demanded rack position is reached. These control signals may be generated using a PI control strategy whereby measurements of the wheel steering angle are compared with a demanded steering angle to produce an error signal that the PI control strategy attempts to drive to zero.

The vehicle 10 includes a steering wheel 15 or yoke which can be turned by the driver to steer the vehicle. It is within the scope of this disclosure that a steering wheel is omitted entirely with the steering before performed autonomously by the vehicle.

Where a steering wheel 15 is provided as shown, this can be turned by the driver and this is detected by a sensor together with the torque applied by the driver. A second motor is provided which outputs a torque of opposite sense to that applied by the driver in order to provide the driver with a feel for the forces acting on the front road wheels. In this example there is no direct mechanical connection from the steering wheel to the front road wheels.

It is to be noted that it is within the scope of this disclosure for a steering wheel to be omitted completely where the control of the front wheel steering angle is performed autonomously by the vehicle.

The two rear wheels 16,17 of the vehicle are connected to a very similar steering rack 18 which is displaced by a third motor (not shown). The rack is moved by the third motor in response to control signals from a rear wheel steering control circuit (not shown). At low speeds the rear wheels 16,17 may be turned in the opposite direction to the front wheels and at higher speeds may be turned in the opposite direction. During normal driving, the rear wheels may be steered as a function of the steering wheel position and the vehicle speed so that the driver has direct control. In an emergency or a fault mode, the rear wheels may be steered independently of the movement of the steering wheel by the driver.

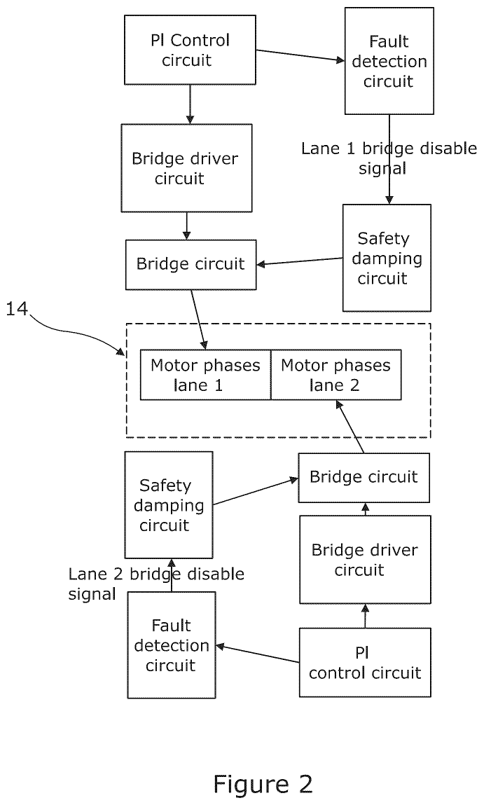

The first motor 14 associated with the front steering rack forms a part of a motor circuit shown in more detail in FIG. 2. In this figure the central block with the dashed outline represents the motor which has multiple lanes, each comprising a set of three phase windings. Above this block are the parts of a first lane of the motor circuit and below this are the parts of the second lane of the motor circuit. The motor in this example is a dual lane motor which means it has two sets of independent phase windings. Any one set of phases can be supplied with current to generate a motor torque. In normal operation the two lanes may be used together so both contribute to the overall torque applied by the first motor to the front steering rack or only one may be used at a time as determined by the control strategy of the steering system. As shown In FIG. 8 the motor has two sets of three phases, each set of phases connected at a start point in this example although other configurations are possible within the scope of the disclosure.

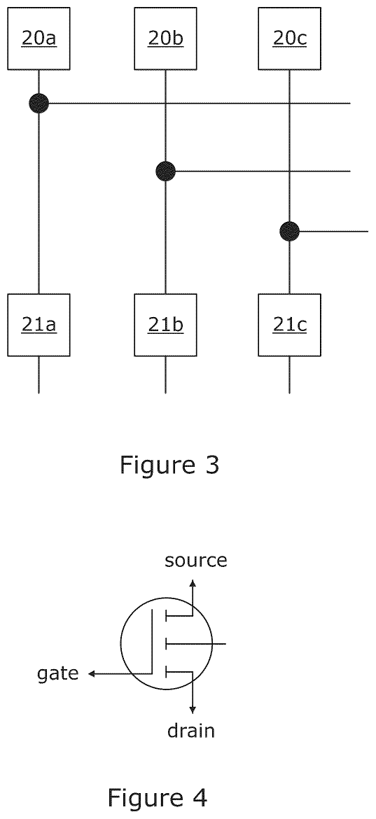

Each lane comprises a PI, or PID control circuit. The role of the circuit is to take a motor current demand and compare this with the actual current flowing in the motor to generate an error signal which is fed to the PI or PID controller. The PI control circuit outputs control signals that represent the current demanded from the motor, the currents being selected so that the actual motor current closely follows the demanded current over time. These control signals are fed to a bridge driver circuit which converts the signals into a set of a PWM voltage waveforms, one for each phase of the motor for the lane. These signals are then fed to the gate of the switches of a bridge circuit shown in FIG. 3. The bridge circuit comprises three pairs of MOSFET switches. Each pair comprises a top switch in series with a bottom switch and a central tap between the two switches connects to a motor phase. For each motor phase a top switch 20a,20b,20c of a pair of switches selectively connects the phase to the positive voltage of a power supply and a bottom switch 21a, 21b, 21c of the same pair selectively connects the phase to the ground. The bridge driver circuit in normal use generates PWM waveforms that ensure that the top and bottom switches of a pair are switched on at the same time as this would short the power supply to ground. The control of a motor using PWM in this manner is well known and will not be described in detail here.

Each lane also includes a fault detection circuit and a safety damping circuit. The fault detection circuit monitors the control circuit for the lane to ensure that usable control signals are being output for the bridge driver circuit. The output of the fault detection circuit is a bridge driver disable signal. When the bridge is not to be disabled the value of this signal is held low and the bridge driver is to be disabled the output is held at a non-zero voltage, such as the supply voltage or a value close to that. In this example, the power supply is configured to monitor itself and the control circuit, the control circuit is configured to is monitor itself, the power supply to that control circuit and also monitors the bridge circuit and the bridge driver circuit. The bridge driver is configured to monitor the bridge circuit and itself. When any of these determines that a fault is present, they toggle a common /SOFF (Safety Off) signal for the lane containing the faulty circuit. If both lanes set /SOFF to Low, the safety damping will be triggered.

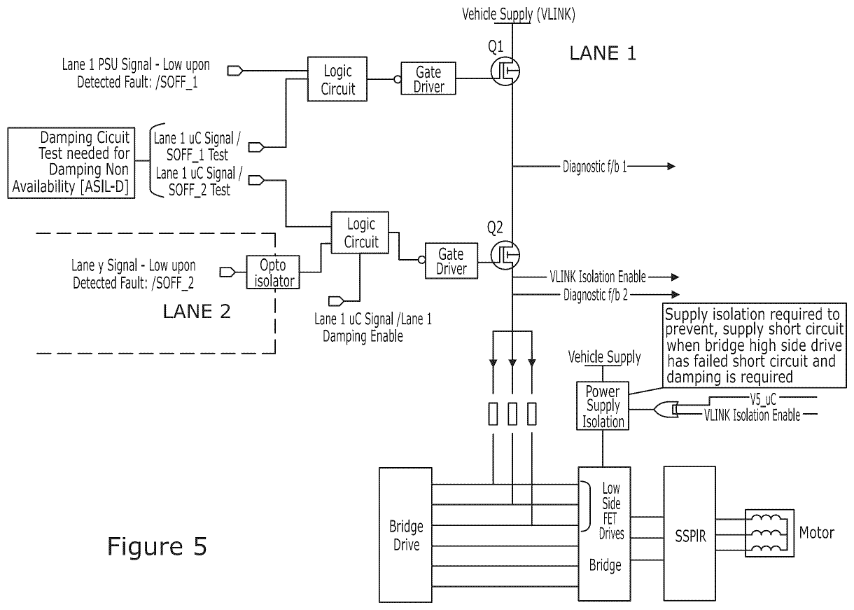

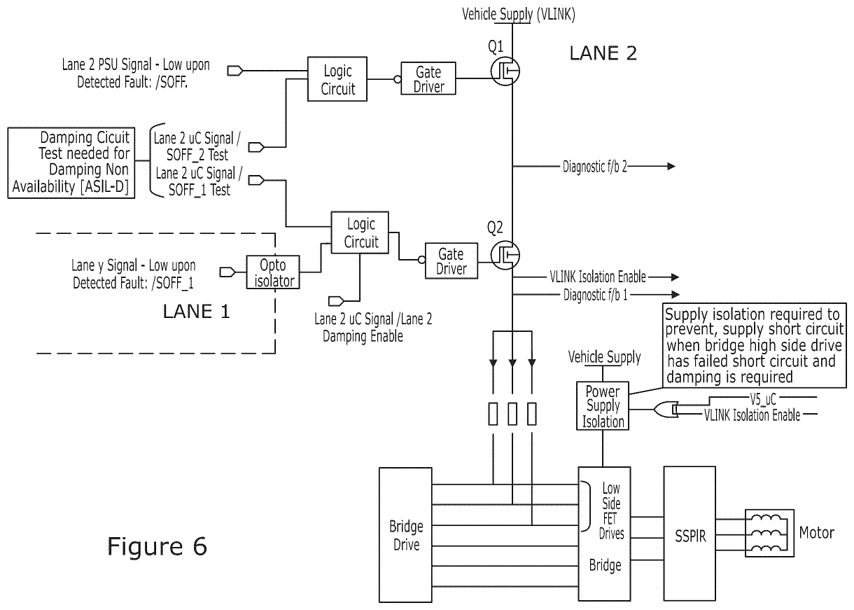

The safety damping circuit can be seen in more detail in FIGS. 5 and 6. The safety damping circuit comprises a pair of switches Q1 and Q2 that are connected in series with one side of the pair of switches being connected to the power supply and the other side being connected to the gate of each bottom switch of the bridge through a network of diodes and resistors that limit the magnitude of the current that is drawn from the power supply through Q1 and Q2 when they are both open. The gate of each switch Q1 and Q2 is connected to a gate driver which in turn is fed by the bridge driver disable signal for each lane. These switches Q1 and Q2 are normally OFF so no current can flow from source to drain but will each switch ON when their associated bridge driver disable signal goes high. When both Q1 and Q2 are on the bottom FETS are all supplied with a voltage sufficiently high for them to be turned ON which shorts out all three phases of the motor lane to the ground potential. Note that the actual voltage applied will depend on the voltages dropped across Q1 and Q2 and the voltage dropped across the resistors and diodes and also on the supply voltage of the power supply.

FIG. 5 shows this arrangement for a first lane. FIG. 6 show that same arrangement may also be provided for the second lane. It is within the scope of the disclosure to only provide for a safety damping circuit on one lane but having this for both lanes allows them both to provide damping of the motor, increasing the resistance to turning of the motor. If the motor lanes are identical, the braking torque achieve using both lanes will be double that which can be achieved from one lane.

Also shown in FIG. 5 and FIG. 6 is a power supply isolation circuit. This circuit receives a signal from the safety damping circuit when both switches Q1, Q2 or Q3 and Q4 are turned ON and acts to switch off the power supply to the bridge of the lane being damped. This ensures that there can be no accidental short of the power supply to ground through the turned ON bottom switches of the bridge if a fault causes a top switch on the bridge to accidentally be opened or fail in an open conductive state where current can flow between source and drain.

In addition, an optional damping circuit test block can be seen in FIGS. 5 and 6. The optional test block performs tests that are necessary to ensure that there are no faults in the damping circuit that could lead to it either not operating when required or being triggering when not wanted.

To run the test in lane, the test block will ensure that the Bridge Driver is disabled and the Bridge Supply is OFF & switch on Q1 while Q2 is off to check that Bridge Bottom FET's do not turn on. It will then switch Q1 off & Q2 on and check that Bridge Bottom FET's remain off. If required, it will then force both Q1 & Q2 on to check that damping is triggered. This can be carried out with single SSPIR FET's closed, to avoid damping & prove that each Bridge Bottom FET is being switched.

A check may also be performed to detect whether there is an error from the optical isolator shown in the figures. If the other lane is operational, the Safe Off signal will be communicated via an Inter Lane bus so that the SPI reported state can be compared with the signal in lane. If the optical isolator signal is low, the power up testing will be adjusted accordingly since it will overrule the in-lane microcontroller supply.

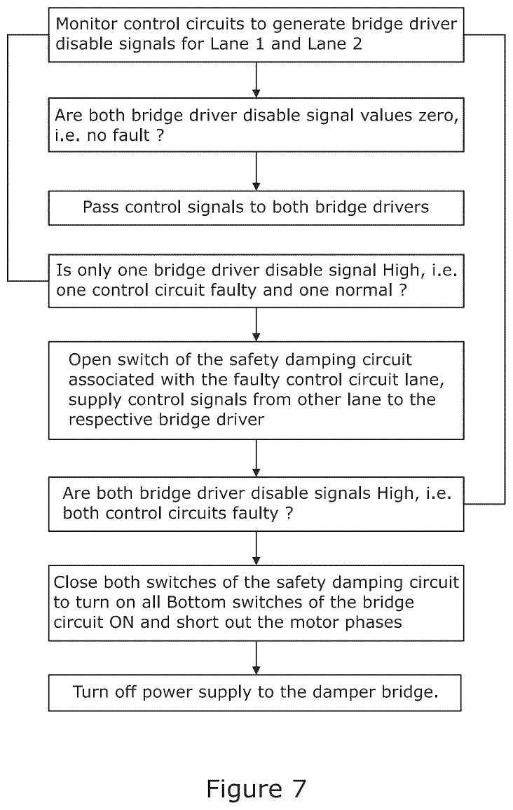

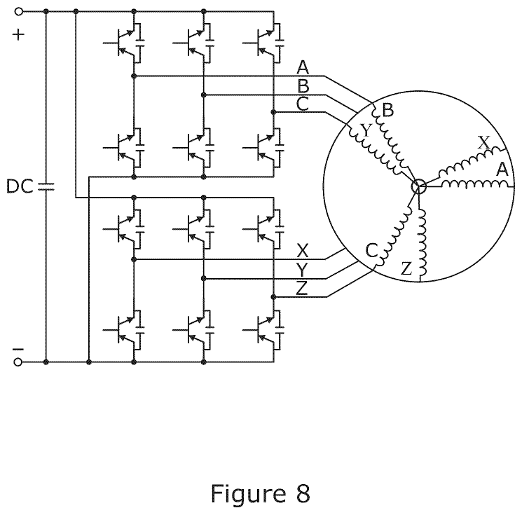

FIG. 7 is a flowchart illustrating the behaviour of the motor circuit of FIG. 2 during normal operation where there are no faults in either of the two control circuits and in the event of a fault of one or both of the control circuits of the motor.

At a first step, the two bridge driver disable signals are monitored. If both indicate that there is no fault of the control circuits control signals from the two control circuits are fed to the respective bridge drivers and the motor is operated to steer the wheels.

If the check indicates that one if faulty, one of the switches of the fault detection circuit is turned ON and the control signals from that control circuit are not fed to the bridge driver of that lane. The other lane is used to control the motor.

If the check indicates that both are faulty the second switch of the fault detection circuit is also turned ON, applying the power supply voltage to the base of each bottom FET of the bridge circuit.

The power supply to the bridge is also turned off so that the top FETS are not connected to a positive supply voltage.

The method of FIG. 7 is duplicated for the second lane where the two lanes are protected.

By damping one or both lanes of the motor where steering control cannot be provided, the motor will generate a high braking torque in the event that forces applied to the road wheels as the vehicle travels will not rapidly alter the steering angle of the wheels. This prevents rapid unintended changes of direction of the vehicle for occurring. During this condition the rear wheels may be steered in order to move a vehicle safely to a side of a highway before coming to a stop. This rear wheel steering may be performed autonomously by the vehicle or may be performed in response to the driver turning the steering wheel of the vehicle.

1. A method of controlling an electric steering system that includes a multiple phase permanent magnet electric motor having a plurality of motor phases that in normal operation applies a torque to a part of the system connected to the road wheels to control a steering angle of the road wheels, the motor being driven by a bridge circuit that includes a set of switches that can be opened and closed to selectively connect each phase to a supply voltage of a power supply or to a ground in response to signals outputted from a bridge driver circuit, the method comprising, in an event of a fault that prevents the electric motor from applying a torque that enables the roadwheels to be steered, operating switches of the bridge circuit independent of the bridge driver to short each phase of the electric motor so as to dampen a rotation of the electric motor and, at the same time, turn of the power supply to the bridge circuit.

2. A method according to claim 1 in which the bridge circuit comprises for each phase, an upper switch, which when closed connects a phase to the power supply, and a lower switch, which connects the phase to a ground, the method comprising shorting each phase by closing the lower side switch of each phase of the bridge circuit.

3. A method according claim 2, comprising overriding the operation of lower bridge switches by the bridge driver to prevent the bridge driver from opening the lower switches.

4. A method according to claim 2, in which the switches comprise transistors which are turned ON and OFF by the bridge driver circuit applying a non-zero valued voltage drive signal to a gate of the switch and the method comprises shorting a phase by connecting the gate or base of each switch to a non-zero value voltage to turn the switch ON.

5. A method according to claim 1, comprising monitoring the control circuit, generating a bridge driver disable signal in the event of a fault of the control circuit, and monitoring the bridge driver disable signal to determine when to short the phases of the electric motor to damp rotation of the motor.

6. A multiple lane motor circuit for driving a multiple lane motor of an electric steering system, each lane of the motor comprising a plurality of motor phase windings and permanent magnets, the multiple lane motor circuit comprising:
a first motor lane comprising:
a first bridge circuit comprising a set of top switches that each selectively connect a respective phase of the multiple lane motor to a supply voltage of a power supply and a set of bottom switches that each selectively connect a respective phase of the multiple lane motor to ground;
a first bridge driver circuit which outputs respectively drive signals for each of the switches of the bridge so as to control the voltage applied to each phase over time in response to a set of control signals thereby controlling the current flowing through each phase of the multiple lane motor, a
a first control circuit which is configured to output control signals to the bridge driver; and
a first fault detection circuit that outputs a bridge driver disable signal in the event of a fault in the lane to disable the bridge driver associated with the lane,
a second motor lane comprising:
a second bridge circuit comprising a set of top switches that each selectively connect a respective phase of the motor to a supply voltage of a power supply and a set of bottom switches that each selectively connect a respective phase of the motor to ground;
a second bridge driver circuit which outputs respectively drive signals for each of the switches of the bridge so as to control the voltage applied to each phase over time in response to a set of control signals thereby controlling the current flowing through each phase of the motor, and
a second controller which is configured to output control signals to the bridge driver; and
a second fault detection circuit that outputs a bridge driver disable signal in the event of a fault in the lane to disable the bridge driver associated with the lane,
and further comprising a monitoring arrangement arranged to monitor the bridge driver disable signals and a safety damping circuit configured so that in the event that the monitoring arrangement determines that the bridge driver disable signals indicate that the control circuits of both lanes are faulty the safety damping circuit causes the bottom switches of the bridge driver to short each phase of at least one lane of the so as to dampen the rotation of the multiple lane motor and at the same time isolates the top switches of the bridge circuit from the power supply.

7. A multiple lane motor circuit according to claim 6 in which the safety damping circuit comprises a pair of switches arranged in series between a positive supply voltage and a switch of each phase of at least one lane of the multiple lane motor, the switches comprising a first switch which is normally open and closed when the first bridge driver disable signal instructs disabling of the first bridge driver circuit and a second switch which is normally open and is closed when the second bridge driver disable signal instructs disabling of the second bridge driver circuit, configured such that only when both switches are closed is the short circuit applied to each phase of at least one lane to provide damping of the multiple lane motor through the generation or braking torque.

8. A multiple lane motor circuit according to claim 6 in which each of the two switches of the safety damping circuit comprises a transistor MOSFET, the safety damping circuit being adapted to cause the switch to close by applying a positive voltage to a base of the switch to turn on the transistor, thereby allowing current to flow between the source and the drain.

9. A multiple lane motor circuit according to claim 6, additionally including an isolation circuit comprising a set of isolating switches, one isolating switch being located in series between the bridge circuit and each motor phase, each isolating switch being normally closed.

10. A multiple lane motor circuit according to claim 6, further comprising a duplicate safety damping circuit that comprises a pair of switches arranged in series between a positive supply and an end of each phase of the second lane of the motor, a first switch which is normally open and closed when the first bridge driver disable signal instructs disabling of the first lane and a second first switch which is normally open and is closed when the second bridge driver disable signal instructs disabling of the second lane, both switches needing to close to apply the positive voltage to the ends of each phase of the second lane.

11. A multiple lane motor circuit according to claim 6 in which the bridge disable signal or signals are input to a power supply isolation block that isolates the top switches of the bridge from the supply to prevent the phases receiving the positive voltage from the power supply.

12. A multiple lane motor circuit according to claim 6 in which the safety damping circuit comprises a pair of switches arranged in series between a positive voltage of a power supply and the gate of each lower switch of the bridge circuit, a first switch being normally open and closed when the first bridge driver disable signal instructs disabling of the first lane and a second first switch which is normally open and is closed when the second bridge driver disable signal instructs disabling of the second lane, both switches needing to close to apply the positive voltage to the gates of each phase of the lane.

13. A front axle assembly for a steer by wire vehicle including a motor circuit of claim 6 and a multi phase dual lane permanent magnet electric motor which is operable to steer the front wheels of the vehicle.
